(19) United States
(12) Patent Application Publication
(10) Pub. No.: US 2017/0130307 A1
(43) Pub. Date: May 11, 2017

(54) ALLOY COMPOSITION FOR THERMAL SPRAY APPLICATION

(71) Applicant: GM Global Technology Operations LLC, Detroit, MI (US)

(72) Inventors: Huaxin Li, Rochester Hills, MI (US); Martin S. Kramer, Clarkston, MI (US); Jianghuai Yang, Rochester Hills, MI (US); Ronald Sanders, Daxweiler (DE)

(21) Appl. No.: 14/934,225

(22) Filed: Nov. 6, 2015

(51) Int. Cl. C22C 38/58; C23C 4/073; C22C 38/50; C22C 38/44; C22C 38/38; F02F 7/00; C22C 38/22; C22C 38/06; C22C 38/04; C22C 38/02; C22C 38/00; F02F 1/00; C23C 4/134; C22C 38/28

(52) U.S. Cl. CPC C22C 38/58; C23C 4/134; C23C 4/073; C22C 38/50; C22C 38/44; C22C 38/38; C22C 38/28; C22C 38/22; C22C 38/06; C22C 38/04; C22C 38/02; C22C 38/002; F02F 1/004; F02F 7/0007; F02F 7/0085

(57) ABSTRACT

An iron-based alloy for use in a plasma transferred wire arc thermal spray apparatus includes a high sulfur steel alloy in a stainless and non-stainless forms including a high aluminum and high titanium content. The alloy has significant improvements in the elimination of spray coating cracking, reduction of machining cost, and improved lubrication performance.

### TECHNICAL FIELD

The present disclosure relates to ferrous metallurgy and more particularly to ferrous alloy compositions for use in thermal spray metal deposition methods.

### BACKGROUND

The statements in this section merely provide background information related to the present disclosure and may or may not constitute prior art.

A typical thermal spray method uses many types of metal compositions in order to achieve particular finished mechanical properties. In some applications, the alloy coating is machined after the thermal spray process. For example, a thermal spray coating of a cylinder bore of an engine block requires a first machining operation to size the bore for proper piston fit. A second machining operation may be employed to impart a particular surface finish or pattern on the surface of the alloy coating for lubrication and wear resistance.

While current thermal spray material compositions achieve their intended purpose, the need for new and improved material compositions which exhibit improved performance, especially from the standpoints of coating cracking, machinability, lubrication, and mechanical properties, is constant. Accordingly, there is a need in the art for an improved thermal spray material composition that improves upon these performance properties.

### SUMMARY

The present invention is an iron-based alloy for deposition onto a metal surface such as aluminum using a plasma transferred wire arc thermal spray apparatus. The alloy includes Carbon C in the amount from about 0.10 to about 0.75 wt %, Manganese Mn in the amount from about 0.50 to about 2.50 wt %, Silicon Si in the amount from about 0.30 to about 1.50 wt %, Aluminum Al in the amount from about 0.40 to about 3.00 wt %, and Sulfur S in the amount from about 0.10 to about 0.35 wt %. The balance of the alloy is Iron Fe.

In another example of the present invention, the alloy further includes Carbon C in the amount from about 0.15 to about 0.75 wt %, Chromium Cr in the amount from about 0.00 to about 3.00 wt %, Molybdenum Mo in the amount from about 0.00 to about 1.00 wt %, Silicon Si in the amount from about 0.30 to about 1.50 wt %, Aluminum Al in the amount from about 0.40 to about 3.00 wt %, Titanium Ti in the amount from about 0.00 to about 1.00 wt %, and Sulfur S in the amount from about 0.10 to about 0.35 wt %. The balance of the alloy is Iron Fe.

In yet another example of the present invention, the alloy further includes Carbon C in the amount from about 0.28 to about 0.35 wt %, Manganese Mn in the amount from about 1.35 to about 1.65 wt %, Chromium Cr in the amount from about 0.95 to about 2.00 wt %, Molybdenum Mo in the amount from about 0.00 to about 0.40 wt %, Silicon Si in the amount from about 0.50 to about 1.00 wt %, Aluminum Al in the amount from about 1.10 to about 1.40 wt %, Titanium Ti in the amount from about 0.00 to about 0.60 wt %, Sulfur S in the amount from about 0.24 to about 0.33 wt %, and Phosphorus P in the amount from about 0.00 to about 0.03 wt %. The balance of the alloy is Iron Fe.

In yet another example of the present invention, the alloy further includes Carbon C in the amount from about 0.25 to about 0.30 wt %, Manganese Mn in the amount from about 1.35 to about 1.65 wt %, Silicon Si in the amount from about 0.50 to about 1.00 wt %, Aluminum Al in the amount from about 1.10 to about 1.40 wt %, Sulfur S in the amount from about 0.24 to about 0.33 wt %, and Phosphorus P in the amount from about 0.00 to about 0.03 wt %. The balance of the alloy is Iron Fe.

In yet another example of the present invention, the alloy further includes Carbon C in the amount from about 0.10 to about 0.60 wt %, Manganese Mn from about 1.00 to about 2.00 wt %, Chromium Cr from about 8.00 to about 30.00 wt %, Molybdenum Mo from about 0.00 to about 3.00 wt %, Silicon Si from about 0.30 to about 1.50 wt %, Aluminum Al from about 0.40 to about 3.00 wt %, Titanium Ti from about 0.00 to about 1.00 wt %, Sulfur S from about 0.10 to about 0.33 wt %, and Nickel Ni from about 0.00 to about 14.00 wt %. The balance of the alloy is Iron Fe.

In yet another example of the present invention, the alloy is formed into one of a wire and a powder for use in a plasma transferred wire arc thermal spray apparatus.

In yet another example of the present invention, the alloy is deposited onto a cylinder wall of a cylinder block of an internal combustion engine.

In yet another example of the present invention, the cylinder block is manufactured from a cast aluminum alloy.

The above features and advantages and other features and advantages of the present invention are readily apparent from the following detailed description of the best modes for carrying out the invention when taken in connection with the accompanying drawings.

### BRIEF DESCRIPTION OF THE DRAWING

FIG. 1 is a perspective view of a cylinder block for an internal combustion engine in accordance with the present invention;

FIG. 2 is a cross section of a coated cylinder bore wall of a cylinder block in accordance with the present invention; and

FIG. 3 is a table of alloy compositions for use in the coating of the cylinder bore wall in accordance with the present invention.

### DESCRIPTION

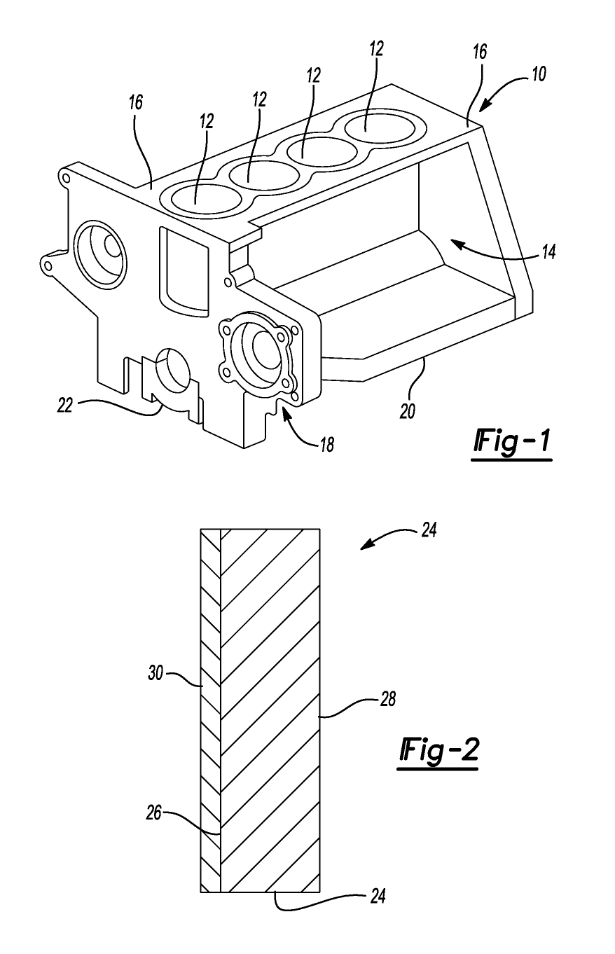

Referring to FIG. 1, a cylinder block for an internal combustion engine, generally indicated by reference number 10, is illustrated and will now be described. The cylinder block 10 has several major features including a plurality of cylinder bores 12, a crankcase portion 14, a head deck 16, a water pump portion 18, a pan rail 20, and bearing caps 22. More specifically, the plurality of cylinder bores 12 can include from two cylinder bores to sixteen or more cylinder bores. In this example, four cylinder bores 12 are aligned such that each axis of the cylinder bores 12 are parallel to each other. In other examples, the cylinder bores 12 may be arranged in the shape of a “V”, flat, or other arrangements without departing from the scope of the invention. A top end of each cylinder bore 12 terminates at the head deck 16 while the bottom end of each cylinder bore 12 terminates at the crankcase portion 14 of the cylinder block 10.

Turning now to FIG. 2 with continuing reference to FIG. 1, a cross section of a cylinder bore wall 24 is illustrated and will now be described. The cylinder bore wall 24 includes an inner surface or circumference 26 and an outer surface 28. The outer surface 28 may be adjacent to a cavity utilized as water cooling passages or it may be utilized as a cylinder bore wall 24 of the adjacent cylinder bore 12. In either aspect, the inner surface 26 of the cylinder bore wall 24 is exposed to a reciprocating piston (not shown) when in operation. The inner surface 26 of the cylinder bore wall 24 includes a coating 30 of material that is bonded to a parent material of the cylinder bore wall 24. In some examples, the parent material of the cylinder bore wall 24 may be a cast iron alloy or an aluminum alloy. However, other types of alloys may be used without departing from the scope of the invention. The coating 30 is bonded to the parent material of the cylinder bore wall 24 using any one of a number of methods. One such method is a plasma transferred wire arc thermal spray apparatus as explained in U.S. Pat. No. 5,938,944. Other similar methods or variations of the disclosed methods may be used without departing from the scope of the invention. After the coating 30 is applied to the inner surface 26 of the cylinder bore wall 24, an inner surface 32 of the coating 30 may be machined to achieve a precise fit with the piston and achieve a prescribed surface finish or hone pattern.

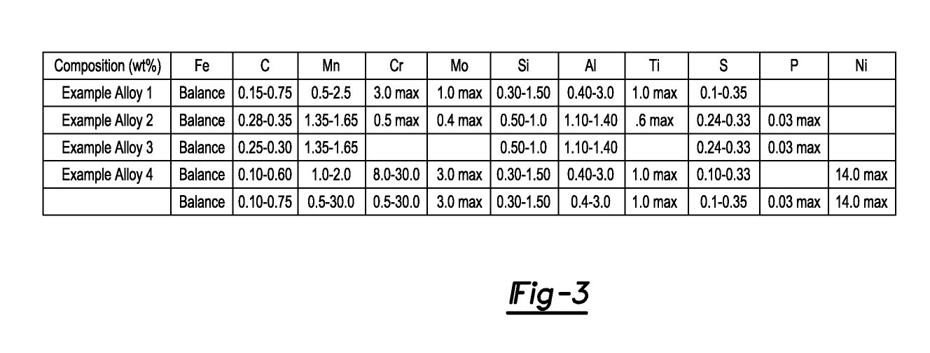

Turning now to FIG. 3 with continuing reference to FIG. 2, a number of example alloys are shown in table format and will now be described. The alloys 1-4 are prepared in wire or powder form and used in the thermal spray apparatus to deposit the alloys 1-4 on the inner surface 26 of the cylinder bore wall 24 to form the coating 30. Example Alloy 1 is based on a carbon steel alloy in particular having Carbon C in the range of about 0.15 to about 0.75 weight percent wt %, Manganese Mn in the range of about 0.50 to about 2.50 wt %, Chromium Cr at about 3.00 wt % maximum, Molybdenum Mo at about 1.00 wt % maximum, Silicon Si in the range of about 0.30 to about 1.50 wt %, Aluminum Al in the range of about 0.40 to about 3.00 wt %, Titanium Ti at about 1.00 wt % maximum, and Sulfur S in the range about 0.10 to about 0.35 wt % with the balance Iron Fe. More specifically, the Carbon C content is prescribed to improve strength and overcome cracking of the finished coating 30. Manganese Mn is prescribed for promoting martenisitic transformation during coating cooling, and Molybdenum Mo for improved lubrication and pitting resistance, and Aluminum Al and Titanium Ti content is prescribed to tailor oxides formed in the thermal spraying process. The Aluminum oxide Al₂O₃ and Titanium oxide TiO₂ aid in the wear properties of the finished coating 30. The Sulfur S content forms Sulfides S² to improve machinability and lubrication of the coating 30.

Example Alloy 2 is based on a steel alloy in particular having Carbon C in the range of about 0.28 to about 0.35 weight percent wt %, Manganese Mn in the range of about 1.35 to about 1.65 wt %, Chromium Cr at about 0.50 wt % maximum, Molybdenum Mo at about 0.40 wt % maximum, Silicon Si in the range of about 0.50 to about 1.00 wt %, Aluminum Al in the range of about 1.10 to about 1.40 wt %, Titanium Ti at about 0.60 wt % maximum, Sulfur S in the range about 0.24 to about 0.33 wt %, and Phosphorus P at about 0.03 wt % maximum, with the balance Iron Fe. More specifically, the Carbon C content is prescribed to improve strength and overcome cracking of the finished coating 30. Aluminum Al and Titanium Ti content is prescribed to tailor oxides formed in the thermal spraying process. The Aluminum oxide Al₂O₃ and Titanium oxide TiO₂ aid in the wear and friction properties of the finished coating 30. The Sulfur S content forms Sulfides S² to improve machinability and lubrication of the coating 30.

Example Alloy 3 is based on a steel alloy in particular having Carbon C in the range of about 0.25 to about 0.30 weight percent wt %, Manganese Mn in the range of about 1.35 to about 1.65 wt %, Silicon Si in the range of about 0.50 to about 1.00 wt %, Aluminum Al in the range of about 1.10 to about 1.40 wt %, Sulfur S in the range about 0.24 to about 0.33 wt %, and Phosphorus P at about 0.03 wt % maximum, with the balance Iron Fe. More specifically, the Carbon C content is prescribed to improve strength and overcome cracking of the finished coating 30. Aluminum Al content is prescribed to tailor oxides formed in the thermal spraying process. The Aluminum oxide Al₂O₃ aid in the wear and friction properties of the finished coating 30. The Sulfur S content forms Sulfides S² to improve machinability and lubrication of the coating 30.

Example Alloy 4 is based on a stainless steel alloy in particular having Carbon C in the range of about 0.10 to about 0.60 weight percent wt %, Manganese Mn in the range of about 1.00 to about 2.00 wt %, Chromium Cr in the range of about 8.00 to about 30.00 wt %, Molybdenum Mo at about 3.00 wt % maximum, Silicon Si in the range of about 0.30 to about 1.50 wt %, Aluminum Al in the range of about 0.40 to about 3.00 wt %, Titanium Ti at about 1.00 wt % maximum, Sulfur S in the range about 0.10 to about 0.33 wt %, and Nickle Ni at about 14.00 wt % maximum, with the balance Iron Fe. More specifically, the Carbon C content is prescribed to improve strength and overcome cracking of the finished coating 30. Aluminum Al and Titanium Ti content is prescribed to tailor oxides formed in the thermal spraying process. The Aluminum oxide Al₂O₃ and Titanium oxide TiO₂ aid in the wear and friction properties of the finished coating 30. The Sulfur S content forms Sulfides S² to improve machinability and lubrication of the coating 30.

While the best modes for carrying out the invention have been described in detail, those familiar with the art to which this invention relates will recognize various alternative designs and examples for practicing the invention within the scope of the appended claims.

The following is claimed:

1. An iron-based alloy for deposition onto a metal surface using a plasma transferred wire arc thermal spray apparatus, the alloy including:
Carbon C in the amount from about 0.10 to about 0.75 wt %;
Manganese Mn in the amount from about 0.50 to about 2.50 wt %;
Silicon Si in the amount from about 0.30 to about 1.50 wt %;
Aluminum Al in the amount from about 0.40 to about 3.00 wt %, and
Sulfur S in the amount from about 0.10 to about 0.35 wt %; and
wherein the balance is Iron Fe.

2. The iron-based alloy of claim 1 wherein the alloy further includes:
Carbon C in the amount from about 0.15 to about 0.75 wt %;
Chromium Cr in the amount from about 0.00 to about 3.00 wt %;
Molybdenum Mo in the amount from about 0.00 to about 1.00 wt %;
Silicon Si in the amount from about 0.30 to about 1.50 wt %;
Aluminum Al in the amount from about 0.40 to about 3.00 wt %;
Titanium Ti in the amount from about 0.00 to about 1.00 wt %, and
Sulfur S in the amount from about 0.10 to about 0.35 wt %; and
wherein the balance is Iron Fe.

3. The iron-based alloy of claim 1 wherein the alloy further includes:
Carbon C in the amount from about 0.28 to about 0.35 wt %;
Manganese Mn in the amount from about 1.35 to about 1.65 wt %;
Chromium Cr in the amount from about 0.00 to about 0.50 wt %;
Molybdenum Mo in the amount from about 0.00 to about 0.40 wt %;
Silicon Si in the amount from about 0.50 to about 1.00 wt %;
Aluminum Al in the amount from about 1.10 to about 1.40 wt %;
Titanium Ti in the amount from about 0.00 to about 0.60 wt %;
Sulfur S in the amount from about 0.24 to about 0.33 wt %, and
Phosphorus P in the amount from about 0.00 to about 0.03 wt %; and
wherein the balance is Iron Fe.

4. The iron-based alloy of claim 1 wherein the alloy further includes:
Carbon C in the amount from about 0.25 to about 0.30 wt %;
Manganese Mn in the amount from about 1.35 to about 1.65 wt %;
Silicon Si in the amount from about 0.50 to about 1.0 wt %;
Aluminum Al in the amount from about 1.10 to about 1.40 wt %;
Sulfur S in the amount from about 0.24 to about 0.33 wt %, and
Phosphorus P in the amount from about 0.00 to about 0.03 wt %; and
wherein the balance is Iron Fe.

5. The iron-based alloy of claim 1 wherein the alloy further includes:
Carbon C in the amount from about 0.10 to about 0.60 wt %;
Manganese Mn from about 1.00 to about 2.00 wt %;
Chromium Cr from about 8.00 to about 30.00 wt %;
Molybdenum Mo from about 0.00 to about 3.00 wt %;
Silicon Si from about 0.30 to about 1.50 wt %;
Aluminum Al from about 0.40 to about 3.00 wt %;
Titanium Ti from about 0.00 to about 1.00 wt %;
Sulfur S from about 0.10 to about 0.33 wt %, and
Nickel Ni from about 0.00 to about 14.00 wt %; and
wherein the balance is Iron Fe.

6. The iron-based alloy of claim 1 wherein the alloy is formed into at least one of a wire and a powder for use in plasma transferred wire arc thermal spray apparatus.

7. The iron-based alloy of claim 6 wherein the alloy is deposited onto a cylinder wall of a cylinder block of an internal combustion engine.

8. The iron-based alloy of claim 7 wherein the cylinder block is manufactured from a cast aluminum alloy.

9. A cylinder block for an internal combustion engine, the cylinder block including:
a plurality of cylinder bores having an inner bore surface, and wherein the inner bore surface has an iron-based alloy coating deposited on the inner bore surface using a plasma transferred wire arc thermal spray process, and
wherein the iron-based alloy is based on one of SAE 11xx standard steel and a stainless steel.

10. The iron-based alloy of claim 9 wherein the alloy includes:
Carbon C in the amount from about 0.15 to about 0.75 wt %;
Manganese Mn in the amount from about 0.50 to about 2.50 wt %;
Chromium Cr in the amount from about 0.00 to about 3.0 0 wt %;
Molybdenum Mo in the amount from about 0.00 to about 1.00 wt %;
Silicon Si in the amount from about 0.30 to about 1.50 wt %;
Aluminum Al in the amount from about 0.40 to about 3.0 wt %;
Titanium Ti in the amount from about 0.00 to about 1.00 wt %, and
Sulfur S in the amount from about 0.10 to about 0.35 wt %; and
wherein the balance is Iron Fe.

11. The iron-based alloy of claim 9 wherein the alloy includes:
Carbon C in the amount from about 0.28 to about 0.35 wt %;
in the amount from about 1.35 to about 1.65 wt % of Manganese Mn;
in the amount from about 0.95 to about 2.00 wt % of Chromium Cr;
in the amount from about 0.00 to about 0.40 wt % of Molybdenum Mo;
in the amount from about 0.50 to about 1.00 wt % of Silicon Si;
in the amount from about 1.10 to about 1.40 wt % of Aluminum Al;
in the amount from about 0.00 to about 0.60 wt % of Titanium Ti;
in the amount from about 0.24 to about 0.33 wt % of Sulfur S, and
in the amount from about 0.00 to about 0.03 wt % of Phosphorus P; and
wherein the balance is Iron Fe.

12. The iron-based alloy of claim 9 wherein the alloy includes:
Carbon C in the amount from about 0.25 to about 0.30 wt %;
in the amount from about 1.35 to about 1.65 wt % of Manganese Mn;
in the amount from about 0.50 to about 1.0 wt % of Silicon Si;
in the amount from about 1.10 to about 1.40 wt % of Aluminum Al;
in the amount from about 0.24 to about 0.33 wt % of Sulfur S, and
in the amount from about 0.00 to about 0.03 wt % of Phosphorus P; and
wherein the balance is Iron Fe.

13. The iron-based alloy of claim 9 wherein the alloy includes:
Carbon C in the amount from about 0.10 to about 0.6 wt % of Carbon C;
in the amount from about 1.00 to about 2.00 wt % of Manganese Mn;
in the amount from about 8.00 to about 30.00 wt % of Chromium Cr;
in the amount from about 0.00 to about 3.00 wt % of Molybdenum Mo;
in the amount from about 0.30 to about 1.50 wt % of Silicon Si;
in the amount from about 0.40 to about 3.00 wt % of Aluminum Al;
in the amount from about 0.00 to about 1.00 wt % of Titanium Ti;
in the amount from about 0.10 to about 0.33 wt % of Sulfur S, and
in the amount from about 0.00 to about 14.00 wt % of Nickel Ni; and
wherein the balance is Iron Fe.

14. A cylinder block for an internal combustion engine, the cylinder block including:
a plurality of cylinder bores having an inner bore surface, and wherein the inner bore surface has a coating deposited on the inner bore surface using a plasma transferred wire arc thermal spray process, and
wherein the coating is an iron-based alloy that includes:
Carbon C in the amount from about 0.10 to about 0.75 wt %;
Manganese Mn in the amount from about 0.50 to about 2.50 wt %;
Silicon Si in the amount from about 0.30 to about 1.50 wt %;
Aluminum Al in the amount from about 0.40 to about 3.0 wt %, and
Sulfur S in the amount from about 0.10 to about 0.35 wt %; and
wherein the balance is Iron Fe.

15. The iron-based alloy of claim 9 wherein the alloy further includes:
Carbon C in the amount from about 0.15 to about 0.75 wt %;
Chromium Cr in the amount from about 0.00 to about 3.0 wt %;
Molybdenum Mo in the amount from about 0.0 to about 1.0 wt %;
Silicon Si in the amount from about 0.30 to about 1.50 wt %;
Aluminum Al in the amount from about 0.40 to about 3.00 wt %;
Titanium Ti in the amount from about 0.00 to about 1.00 wt %, and
Sulfur S in the amount from about 0.10 to about 0.35 wt %; and
wherein the balance is Iron Fe.

16. The iron-based alloy of claim 9 wherein the alloy further includes:
Carbon C in the amount from about 0.28 to about 0.35 wt %;
Manganese Mn in the amount from about 1.35 to about 1.65 wt %;
Chromium Cr in the amount from about 0.00 to about 0.50 wt %;
Molybdenum Mo in the amount from about 0.00 to about 0.40 wt %;
Silicon Si in the amount from about 0.50 to about 1.0 wt %;
Aluminum Al in the amount from about 1.10 to about 1.40 wt %;
Titanium Ti in the amount from about 0.00 to about 0.60 wt %;
Sulfur S in the amount from about 0.24 to about 0.33 wt %, and
Phosphorus P in the amount from about 0.00 to about 0.03 wt %; and
wherein the balance is Iron Fe.

17. The iron-based alloy of claim 9 wherein the alloy further includes:
Carbon C in the amount from about 0.25 to about 0.30 wt %;
Manganese Mn in the amount from about 1.35 to about 1.65 wt %;
Silicon Si in the amount from about 0.50 to about 1.00 wt %;
Aluminum Al in the amount from about 1.10 to about 1.40 wt %;
Sulfur S in the amount from about 0.24 to about 0.33 wt %, and
Phosphorus P in the amount from about 0.00 to about 0.03 wt %; and
wherein the balance is Iron Fe.

18. The iron-based alloy of claim 9 wherein the alloy further includes:
Carbon C in the amount from about 0.10 to about 0.60 wt %;
Manganese Mn in the amount from about 1.00 to about 2.00 wt %;
Chromium Cr in the amount from about 8.00 to about 30.00 wt %;
Molybdenum Mo Cr in the amount from about 0.00 to about 3.00 wt %;
Silicon Si from in the amount from about 0.30 to about 1.50 wt %;
Aluminum Al in the amount from about 0.40 to about 3.00 wt %;
Titanium Ti in the amount from about 0.00 to about 1.00 wt %;
Sulfur S in the amount from about 0.10 to about 0.33 wt %, and
Nickel Ni in the amount from about 0.00 to about 14.00 wt %; and
wherein the balance is Iron Fe.
